(19) United States
(12) Patent Application Publication
(10) Pub. No.: US 2010/0135564 A1
(43) Pub. Date: Jun. 3, 2010

(54) APPARATUS FOR AND METHOD OF SELECTING MATERIAL TRIPLETS FOR A MULTI-MATERIAL DECOMPOSITION

(76) Inventors: Brian William Thomsen, Milwaukee, WI (US); Paulo Mendonca, Clifton Park, NY (US); Rahul Bhotika, Albany, NY (US)

Correspondence Address: ZIOLKOWSKI PATENT SOLUTIONS GROUP, SC (GEMS), 136 S WISCONSIN ST, PORT WASHINGTON, WI, 53074, US

(21) Appl. No.: 12/644,455

(22) Filed: Dec. 22, 2009

Related U.S. Application Data
(63) Continuation-in-part of application No. 12/315,184, filed on Nov. 28, 2008.
(60) Provisional application No. 61/264,286, filed on Nov. 25, 2009.

(51) Int. Cl. G06K 9/62; H05G 1/60; G01N 23/04

(52) U.S. Cl. 382/131; 378/4; 378/62

(57) ABSTRACT

An imaging system includes an x-ray source configured to emit a beam of x-rays toward an object to be imaged, a detector configured to receive x-rays that are attenuated by the object, a data acquisition system (DAS) operably coupled to the detector, and a computer operably coupled to the DAS. The computer is programmed to obtain scan data with two or more incident energy spectra, identify one or more material triplet combinations based on data obtained prior to obtaining the scan data, decompose the obtained scan data into three or more basis materials based on the identified one or more material triplet combinations, and generate an image using the decomposed scan data.

### CROSS-REFERENCE TO RELATED APPLICATIONS

The present application is a continuation-in-part of and claims priority of U.S. patent application Ser. No. 12/315,184 filed Nov. 28, 2008, and also claims priority of U.S. Provisional Application 61/264,286 filed Nov. 25, 2009.

### BACKGROUND

The subject matter disclosed herein relates to computed tomography (CT) imaging systems and, in particular, to a multi-material decomposition method using dual energy x-ray sources for CT imaging systems.

Typically, in CT imaging systems, an x-ray source emits a fan-shaped or a cone-shaped x-ray beam toward a subject or object, such as a patient or a luggage item positioned on a support. The x-ray beam impinges on a detector assembly at the far side of the subject, comprising a plurality of detector modules, where the intensity of the x-ray beam detected is a function of the attenuation of the x-ray beam by the subject. In known “third generation” CT systems, the x-ray source and the detector assembly partially enclose the subject in a rotatable gantry structure. Data representing the intensity of the detected x-ray beam is collected across a range of gantry angles, and the data are ultimately processed to form an image.

A CT imaging system may be configured as an energy discriminating, a multi energy, and/or a dual energy CT imaging system. Dual energy CT imaging is an imaging procedure in which multiple scans are made of the same target under the same conditions at two different energy levels, or energy spectra, and is used to identify different materials in the target. For example, soft tissue and similar materials having a relatively low density typically attenuate incident x-rays to a lesser degree than does a relatively high density material, such as bone or an iodine contrast agent. It is appreciated in the relevant art that CT imaging performed at two imaging scans, one at a higher x-ray tube voltage level, such as 110 to 150 kVp, and another imaging scan performed at a lower x-ray tube voltage level, such as 60 to 80 kVp, provides more information about the materials being scanned than does a single-energy CT imaging scan.

Data obtained from a dual energy CT image scan can be used to reconstruct images using basis material decomposition computation processes. The generated images are representative of a pair of selected basis material densities. In addition to material density images, dual energy projection data can be used to produce a new image with x-ray attenuation coefficients equivalent to a selected monochromatic energy. Such a monochromatic image may include an image where the intensity values of image voxels are assigned as if a CT image were created by collecting projection data from the subject with a monochromatic x-ray beam.

In the medical imaging field, for example, dual energy CT scans may be performed at a relatively ‘low energy’ level of about 80 kVp, and at a relatively ‘high energy’ level of about 140 kVp, where the scans may be acquired “back-to-back” or interleaved. Special filters may be placed between the x-ray source and energy sensitive detectors such that different detector rows collect projections of different x-ray energy spectra.

The measurements may be obtained by: (i) scanning with two distinctive energy spectra; (ii) detecting photon energy according to energy deposition in the detector, and (iii) photon counting with multiple energy bins. In the absence of object scatter, the CT system can derive the information about object attenuation versus energy based on the signal from two or more regions of photon energy in the spectrum, for example, the low-energy and the high-energy portions of the incident x-ray spectrum. In medical CT, two physical processes dominate the x-ray attenuation: Compton scatter and the photoelectric effect. The detected signals from two energy regions usually provide sufficient information to resolve the energy dependence of the material being imaged. Furthermore, detected signals from the two energy regions provide sufficient information to determine the relative composition of an object composed of two materials.

Using the images obtained during these CT scans, one can generate basis material density images and monochromatic images, that is, images that represent the effect of performing a computed tomography scan with an ideal monochromatic tube source. Given a pair of material density images, it is possible to generate other basis material image pairs. For example, from a water and iodine image of the same anatomy, it is possible to generate a different pair of material density images such as calcium and gadolinium. Similarly, by using a pair of basis material images, one can generate a pair of monochromatic images, each at a specific x-ray energy. Similarly, one can obtain, from a pair of monochromatic images, a pair of basis material image pairs, or a pair of monochromatic images at different energies.

Conventional material basis decompositions utilize the concept that, in the energy region for medical CT, the x-ray attenuation of any given material can be represented by a proper density mix of two other materials, commonly denoted as “basis materials.” The basis material decomposition computing process produces two CT images, each representing the equivalent density of one of the basis materials. Since a material density is independent of x-ray photon energy, the two CT images are largely free of beam-hardening artifacts. An operator can choose the basis material to target a certain material of interest, for example, to enhance the image contrast.

Thus, dual-energy CT is an imaging modality that extends the capabilities of standard CT, and enables the estimation of the full linear attenuation curve for each voxel in the image volume, instead of a scalar image in Hounsfield units. As explained above, this is achieved by acquiring X-ray projections at two different energy spectra and, under careful calibration, reconstructing a material-decomposed image pair. Each co-registered voxel of this pair is a two-dimensional vector corresponding to an estimate, consistent with projection data, for the density of two pre-selected materials making up that voxel. Because the space of linear attenuation curves can be described as a two-dimensional manifold plus a residual difference which is too small to be measured under current CT technology, this decomposition procedure is essentially limited to the specification of only two materials.

Typically, dual-energy CT provides estimates for a linear attenuation curve of an imaged object at each pixel location. However, a more desirable measurement would be a mass attenuation curve, which is the linear attenuation curve multiplied by a respective material density. Thus, the mass attenuation curve is density independent, and it shares with the linear attenuation curve the property that it can be represented as a weighted sum of the curves of other materials. However, the mass attenuation curve has an additional property that the weights in the sum have a defined physical meaning: that they are the mass fractions of the constituent materials in the mix. Therefore, their weights should add to “unity,” or one.

As such, assuming that the mass fractions add to one, and that the mass attenuation coefficients relate back to the linear attenuation coefficients via their respective densities, an additional constraint is thereby imposed on a resulting system of equations that enables determination of at least a third material in a three-material decomposition. Thus, triple material decomposition is possible if certain assumptions can be made regarding this additional constraint.

Solutions include an assumed relationship between given materials and the mixture by using a physicochemical model, as an example. One such solution includes assuming the mixture is an ideal solution, which implies that a volume of the solution at a given temperature and pressure is equal to the volume of its constituent parts at the same temperature and pressure. Under this assumption, the linear attenuation coefficients are thus assumed to be the volume fractions of the constituent materials in the mixture. As such, they add to one, providing an additional constraint over a two-material system and allowing a third material to be included in a decomposition that derives from two scans at different energies.

However, there exist many potential material options and combinations for decomposing in a triple material decomposition. When considering the myriad possible options and the limitation that only three material combinations are to be considered in a triple material decomposition, there are therefore potentially many thousands or hundreds of thousands of material triplets to consider for the triple material decomposition. Although a computing device may be able to generate these many material combinations, the computing device is typically unable to bring in a selection criteria or otherwise discriminate the many possible solutions to find or suggest one or more leading candidate materials combinations.

Thus, there is a need for minimizing the number of material combinations when considering a triple material decomposition.

### BRIEF DESCRIPTION

The invention is directed to a system and method of selecting material triplets for performing a multi-material decomposition.

According to one aspect of the invention, an imaging system includes an x-ray source configured to emit a beam of x-rays toward an object to be imaged, a detector configured to receive x-rays that are attenuated by the object, a data acquisition system (DAS) operably coupled to the detector, and a computer operably coupled to the DAS. The computer is programmed to obtain scan data with two or more incident energy spectra, identify one or more material triplet combinations based on data obtained prior to obtaining the scan data, decompose the obtained scan data into three or more basis materials based on the identified one or more material triplet combinations, and generate an image using the decomposed scan data.

According to another aspect of the invention, a method of multi-energy imaging includes selecting an imaging application for a multi-energy image acquisition, acquiring imaging data, based on the selected imaging application, with an x-ray source powered to a first keV and to a second keV, determining a plurality of three-material combinations based on data obtained prior to acquiring the imaging data, selecting one of the plurality of three-material combinations, decomposing the imaging data into three materials based on the selected three-material combination, and generating an image using the decomposed imaging data.

According to yet another aspect of the invention, a computer readable storage medium having stored thereon a computer program configured to acquire energy-sensitive imaging data of an object, identify at least one possible material triplet of a multi-material combination to a user, receive a user selection of one of the plurality of possible material triplets, and reconstruct an image based on the selected possible material triplets.

### BRIEF DESCRIPTION OF THE DRAWINGS

FIG. 1 is an isometric diagrammatical view of a CT imaging system, in accordance with the prior art.

FIG. 2 is a functional block diagram of the CT imaging system of FIG. 1.

FIG. 3 is a water-component image from a decomposition in two materials, as may be provided by the CT imaging system of FIG. 1 operating in a dual energy mode.

FIG. 4 is an iodine-component image from a decomposition in two materials, as may be provided by the CT imaging system of FIG. 1 operating in a dual energy mode.

FIG. 5 is a monochromatic image showing attenuation at 70 keV, from a decomposition into two monochromatic images, as may be obtained by the CT imaging system of FIG. 1 operating in a dual energy mode.

FIG. 6 is a monochromatic image showing attenuation at 140 keV, from a decomposition into two monochromatic images, as may be obtained by the CT imaging system of FIG. 1 operating in a dual energy mode.

FIG. 7 is a flow diagram illustrating the operation of a dual-energy CT imaging system functioning to provide multi-material decomposition, in accordance with the disclosed method.

FIG. 8 is a graph illustrating a convex polytope of linear attenuation coefficients at nominal density.

FIG. 9 is a an air-component image from a multi-material decomposition, obtained in accordance with the disclosed method.

FIG. 10 is a fat-component image obtained from the multi-material decomposition process used to produce the image of FIG. 9.

FIG. 11 is a blood-component image obtained from the multi-material decomposition process used to produce the image of FIG. 9.

FIG. 12 is a bone-component image obtained from the multi-material decomposition process used to produce the image of FIG. 9.

FIG. 13 is an Omnipaque-component image obtained from the multi-material decomposition process used to produce the image of FIG. 9.

FIG. 14 is a flow diagram illustrating material triplet selection for a multi-material decomposition.

### DETAILED DESCRIPTION

As noted above, conventional dual-energy CT scanner processing does not evaluate the composition of ‘N≧3’ materials in a material component mix, and is thus generally limited to a decomposition in only two materials (i.e., N=2). In an exemplary aspect of the disclosed method, the capabilities of the dual-energy CT scanner are expanded from producing a material-decomposed image pair to producing a material-decomposed image triplet. The image triplet is obtained by assuming that the various mixtures of substances and tissue types found in the human body have physicochemical properties substantially equivalent to those of what is herein denoted as an ‘ideal material solution.’ This can also be done by using a model for the excess free energy of the mixture. Using this equivalence provides a model for the density of an imaged material mixture, where the model complements the image information provided by the conventional CT data. Under this model, the mass attenuation curve of a particular voxel in a CT image is estimated, and a material-decomposed image triplet is derived (i.e., N=3). In another exemplary aspect of the disclosed method, more than three pre-selected materials can be decomposed by regularizing an otherwise under-constrained solution of a system of equations with a suitable function, and solving the resulting optimization problem. The disclosed method may also use pre-computed lookup tables for faster decomposition.

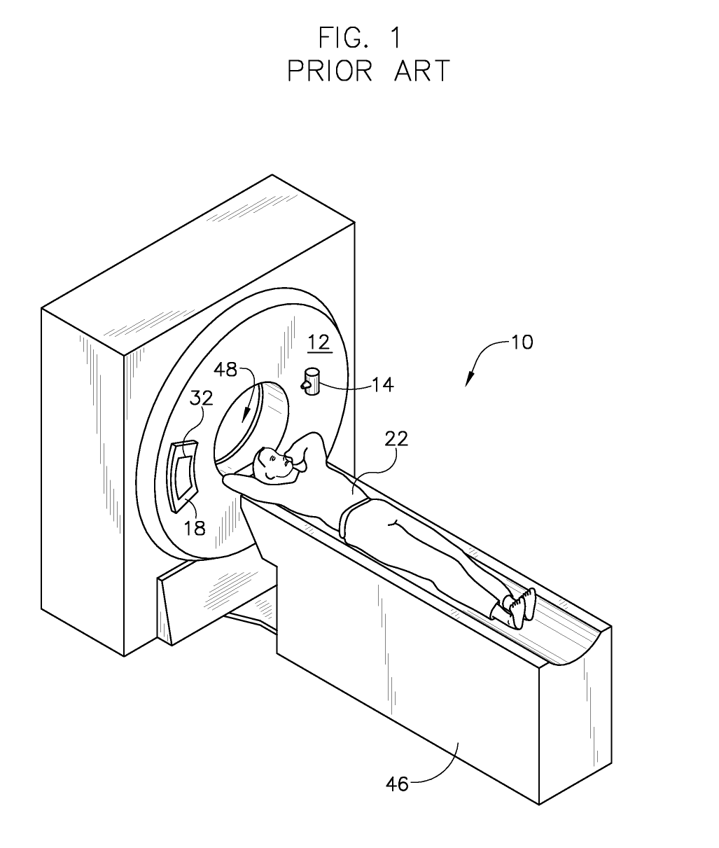

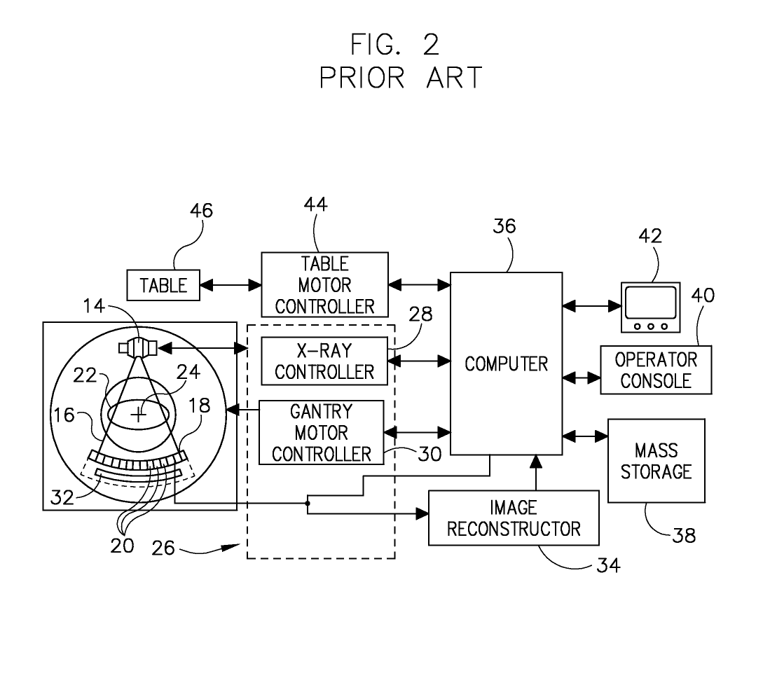

There is shown in the isometric diagrammatical illustration of FIG. 1 a dual-energy CT imaging system 10 configured to perform computed tomography imaging by means of photon counting and energy discrimination of x-rays at high flux rates, as is known in the relevant art. Imaging may be performed by, for example, a CT number difference decomposition, a basis material decomposition, a Compton and photoelectric decomposition, or a logarithmic subtraction decomposition. The dual-energy CT imaging system 10 comprises a gantry 12, with a collimator assembly 18, a data acquisition system 32, and an x-ray source 14 disposed on the gantry 12 as shown. A table 46 serves to move all or part of a patient 22 through a gantry opening 48 in the gantry 12.

The x-ray source 14 projects a beam of x-rays 16 through the patient 22 onto a plurality of detector modules 20 in a detector assembly which includes the collimator assembly 18 and the data acquisition system 32. In a typical embodiment, the detector assembly may comprise sixty four rows of voxel elements to enable sixty four simultaneous “slices of data” to be collected with each rotation of the gantry 12.

The plurality of detector modules 20 sense the projected x-rays that pass through the patient 22, and the data acquisition system 32 converts the data to digital signals for subsequent processing. Each detector module 20 produces an analog electrical signal that represents the intensity of an attenuated x-ray beam after it has passed through the patient 22. During a scan to acquire x-ray projection data, the gantry 12 rotates about a center of rotation 24 along with the x-ray source 14 and the detector assembly 15.

The rotation of the gantry 12 and the operation of the x-ray source 14 are controlled by a control mechanism 26. The control mechanism 26 includes an x-ray generator 28 that provides power and timing signals to the x-ray source 14, and a gantry motor controller 30 that controls the rotational speed and position of the gantry 12. An image reconstructor 34 receives sampled and digitized x-ray data from the data acquisition system 32 and performs high speed reconstruction. The reconstructed image is applied as an input to a computer 36 which stores the image in a mass storage device 38.

The computer 36 also receives commands and scanning parameters input from an operator console 40. An associated image display 42, such as a cathode ray tube, allows an operator to observe the reconstructed image and other data from the computer 36. The commands and scanning parameters are used by the computer 36 to provide control signals and information to the data acquisition system 32, the x-ray generator 28, and the gantry motor controller 30. In addition, the computer 36 operates a table motor controller 44 which controls the motorized table 46.

In conventional CT scanner processing, the data produced by the conventional system is an estimate of the linear attenuation curve of the imaged object at each voxel of the CT imaged volume of interest. A linear attenuation curve is a function that allows for the computation of the fraction of photons that travel undisturbed a fixed length of material at a certain density as a function of the energy of such photons. For example, the linear attenuation coefficient of liquid water is 0.294 cm⁻¹ for x-ray photon incident energy of 100 keV. That is, about 74.5% (e^{-0.294}) of the total number of incident photons with energy of 100 keV will be left undisturbed when traveling through 1.0 cm of liquid water having density of 1.00 g/cm³. For photons with energy of 200 keV, the linear attenuation coefficient of liquid water is 0.243 cm⁻¹ and 78.4% (e^{-0.243}) of the total number of incident photons with energy of 200 keV will be left undisturbed when traveling though 1.0 cm of liquid water. In comparison, only 0.007% of photons with energy of 100 keV and 16.46% of photons with energy of 200 keV will travel undisturbed through 1.0 cm of iodine with a density of 4.93 g/cm³ and a linear attenuation coefficient of 1.94 cm⁻¹.

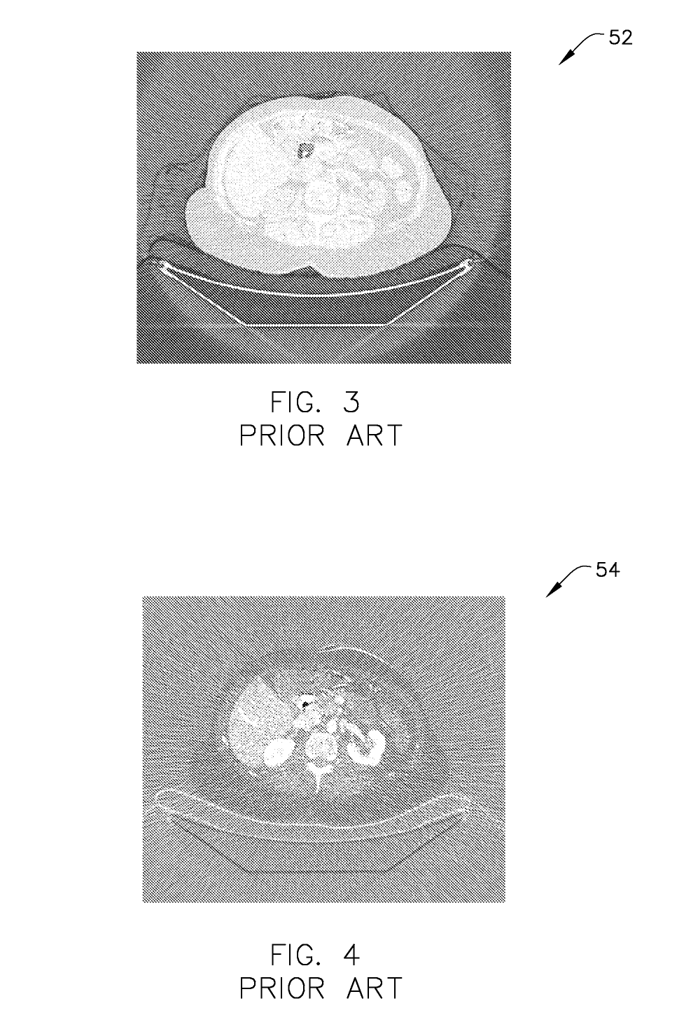

The linear attenuation curve of substantially any material at substantially any density can be uniquely described as a weighted sum of the linear attenuation curves of two other materials. From a mathematical standpoint, the choice of materials (i.e., the material basis) is largely arbitrary but in practical applications the materials found in the imaged pairs are preferred. For example, in a clinical application the operator will generally select materials found in the human body, such as water, fat, and bone. Furthermore, for a given material basis and attenuation curve, the weighting coefficients may be uniquely defined such that the weighted sum of linear attenuation curves is equal to the original attenuation curve. Each weighting coefficient multiplying a linear attenuation curve of a given material can also be multiplied by the nominal density of the material, and the result is a material-density image pair, as shown in FIGS. 3-4.

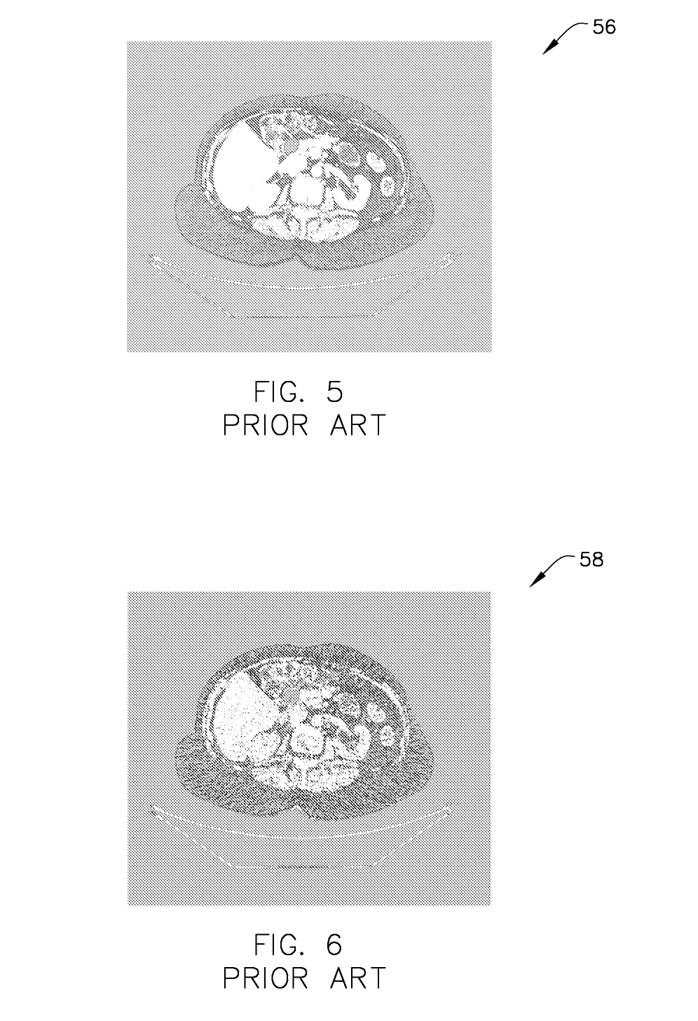

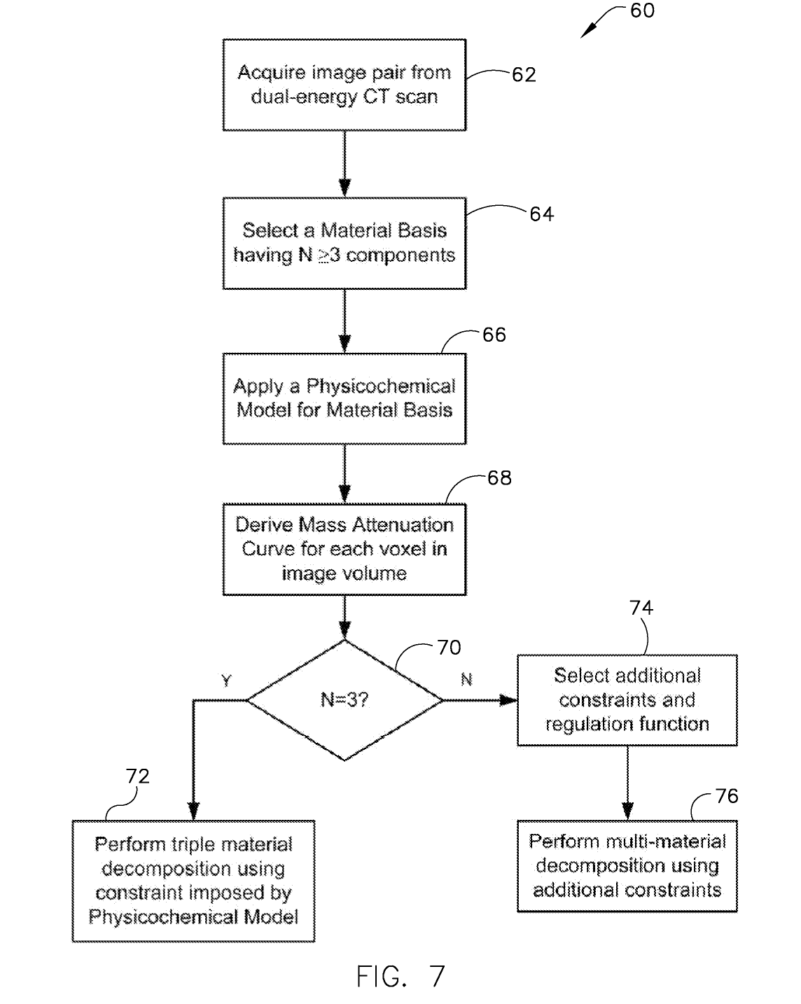

Thus, the computer 36 may decompose a material-density image pair onto the image display 42, such as a water component image 52, shown in FIG. 3, and an iodine component image 54, shown in FIG. 4. In the iodine component image 54, the air region outside the body has resulted in an iodine-equivalent density comparable to that found inside the body. Alternatively, the computer 36 may decompose an energy image pair, such as a first monochromatic image 56 showing attenuation at 70 keV, shown in FIG. 5, and a second monochromatic image 58 showing attenuation at 140 keV, shown in FIG. 6. In the disclosed multi-material decomposition method, which can best be described with reference to a flow diagram 60 shown in FIG. 7, the dual-energy CT imaging system 10 acquires either a material-density image pair or an energy image pair from x-ray projections of two energy spectra, in step 62.

From a mathematical standpoint, there is no constraint on the values of the weighting coefficients necessary to represent a given linear attenuation cure through a weighted sum. Such weighting coefficients could, in principle, even be negative. However, once a negative coefficient is multiplied by a nominal density to produce a density image, the user of the images is left with the problem of interpreting the meaning of the negative density values that result. It is also possible for the weight associated with the linear attenuation curve to assume a value greater than one, and producing a density value greater that the nominal density of the corresponding material. Accordingly, the capabilities of the dual-energy CT scanner 10 can be expanded from producing only a material-decomposed image pair to also producing a material-decomposed image pair more amenable to physical interpretation by enforcing the constraint that the weighting coefficients multiplying a linear attenuation curve must be non-negative and must be less than or equal to one.

In accordance with the disclosed method, the linear attenuation curve is divided by an actual (not nominal) material density to obtain a mass attenuation curve. The resulting mass attenuation curve is density independent, but is material dependent inasmuch as the mass attenuation curve can be represented as the weighted sum of the curves of other materials, similar to the linear attenuation curve. However, the mass attenuation curve has the additional attribute that the weighting coefficients have a well-defined physical meaning as mass fractions of the constituent materials in the material mix. As can be appreciated, the sum of the weighting coefficients in the mass attenuation curve is unity.

As explained in greater detail below, the weighting coefficients α in a weighted sum of linear attenuation coefficients can be related to the weighting coefficients β in a weighted sum of mass attenuation coefficients through a model for how the materials in the material basis mix. For example, by assuming an ideal material solution, the constraint that the weighting coefficients β sum to unity can also be imposed on the weighting coefficients α. This allows for expressing the linear attenuation curve of a given material as a sum of three linear attenuation curves, instead of the conventional two curves. As understood in the relevant art, decomposition into two materials yields a unique pair of weighting coefficients, but without further constraints, the triplet material decomposition produces an infinite set of triplets of weighting coefficients. The set of triplets is one-dimensional, as each triplet in the set can be uniquely associated to a parameter. For any given choice of three materials, this parameter can be interpreted as a ‘dial’ that allows a user to select a triplet of weighting coefficients in the set. The corresponding triplet of weighting coefficients results in the same weighted sum of linear attenuation curves. The weighted sum is satisfied by an arbitrary choice of triplets in the set of triplets. However, if an external constraint is provided, only one ‘dial setting’ will yield a triplet that satisfies the constraint that the weighting coefficients α sum to unity. A relation between α and β can be established if a model for the density of the mix of materials in a given material triplet is available.

In accordance with the disclosed method, physicochemical models can be used to establish relationships between the densities and quantities of given materials and the density of a mix of the given materials, so as to provide for triple material decomposition. One of the physicochemical models used may be that of an ‘ideal solution.’ The disclosed method works from the presumption that the mixture of component materials form an ideal solution, and thus that the volume of the ideal solution, at a given temperature and pressure, is equal to the volume of the component parts of the mix at the same temperature and pressure. Accordingly, it can be shown that the weighting coefficients α in the decomposition of a linear attenuation curve as the weighted sum of linear attenuation curves of other materials have a straightforward physical interpretation—that the weighting coefficients are the volume fractions of the component materials in the material mix.

Referring again to FIG. 7, a material basis is specified having (N≧3) material components, in step 64. The particular material components specified for the material basis may be selected from among the substances and tissue types identified as appearing in the material-density image pair or the energy image pair. In an exemplary embodiment, a selection of fat, bone, and blood may be made via the operator console 40.

It is known in the practice of dual-energy computed tomography that the linear attenuation coefficient of a given material is dependent on: (i) the energy E of the imaging x-rays, (ii) the mass density of the imaged materials, and (iii) the effective atomic number of the imaged materials. The linear attenuation coefficient μ_{L}(E) for a given material can be expressed as the sum

$${μ}_{L} ( E ) = {\sum }_{i}^{N} {α}_{i} {μ}_{L , i} ( E ) , \qquad ( 1 )$$

where αᵢ, i=1, 2, . . . N are energy-independent constants and μ_{L,i}(E), i=1, 2, . . . N are the linear attenuation curves of N arbitrarily pre-selected materials. For materials found in the human body and within the detection range of x-ray energies typically used in medical imaging, the linear attenuation coefficient μ_{L}(E) can be represented by a linear combination of component materials, commonly denoted as a ‘material basis.’ Thus, given a measurement of μ_{L}(E) at two distinct energy levels, for which μ_{L,1} and μ_{L,2} are known, unique solutions can be found for α₁ and α₂ so as to provide a material basis for two component materials. However, a conventional dual-energy CT scanner cannot decompose into a material basis having three or more component materials.

By introducing an additional constraint, the disclosed method provides for decomposition of a third component material. The relation in equation (1) can be expressed in terms of a ‘mass attenuation coefficient’ μ_{M}(E) that is related to the linear attenuation coefficient by the expression

$${μ}_{M} ( E ) = \frac{{μ}_{L} ( E )}{ρ} \qquad ( 2 )$$

where ρ is the mass density of a given component material M, as the component material M is disposed within an imaged aggregate of component materials. Equation (1) can be rewritten as:

$${μ}_{M} ( E ) = {\sum }_{i}^{N} {β}_{i} {μ}_{M , i} ( E ) , \qquad ( 3 )$$

where Equation (3) has the added constraints:

$$\begin{matrix}0 \leq {β}_{i} \leq 1 ; for i = 1 , 2 , … , N & ( 4 a ) \\ {\sum }_{i}^{N} {β}_{i} = 1 & ( 4 b )\end{matrix}$$

The coefficients βᵢ are the mass fractions of each component material in the imaged aggregate of component materials. By establishing a relationship between the energy-independent coefficients αᵢ in Equation (1) and the mass fraction coefficients βᵢ in Equation (2), an additional constraint is provided that provides for a further decomposition by the dual-energy CT scanner.

Referring again to the flow chart 60 of FIG. 7, a physicochemical model, or properties model, for relevant properties (density, volume, etc) of the selected material mix is applied, in step 66. The disclosed process uses a physicochemical model to determine the density of a material mix, bringing in one more constraints to the two constraints already available via the dual-energy image pair. This immediately allows for the decomposition of the images into a material triplet. One model for the density of the imaged aggregate of component materials can be derived by assuming that the component materials form an ‘ideal solution,’ that is, a component mixture having a volume at a given temperature and pressure essentially equal to the sum of the volumes of the individual component parts at the same temperature and pressure. It can be shown that this leads to the following constraints:

$$\begin{matrix}0 \leq {α}_{i} \leq 1 ; for i = 1 , 2 , … , N & ( 5 a ) \\ {\sum }_{i}^{N} {α}_{i} = 1 \\ where & ( 5 b ) \\ {α}_{i} = \frac{{V}_{i}}{{\sum }_{j = 1}^{N} {V}_{j}} & ( 6 )\end{matrix}$$

That is, a well-posed, triple-material decomposition can be obtained from a dual-energy CT scanner image pair by specifying that the component materials in the aggregate mixture of imaged materials comprise an ideal solution.

A derivation or estimate is made of the mass attenuation curve for each voxel in the image volume, at step 68. A determination is made, at decision block 70, whether three material basis components are being used (i.e., N=3). If the response is “yes,” operation proceeds to step 72 at which the triple-material decomposition is solved. If, at decision block 70, the response is “no,” a regularization function is selected, at step 74, to constrain the otherwise ill-posed solution of the multi-material decomposition problem. The multi-material decomposition is solved under the additional physicochemical constraints, at step 76, as described in greater detail below.

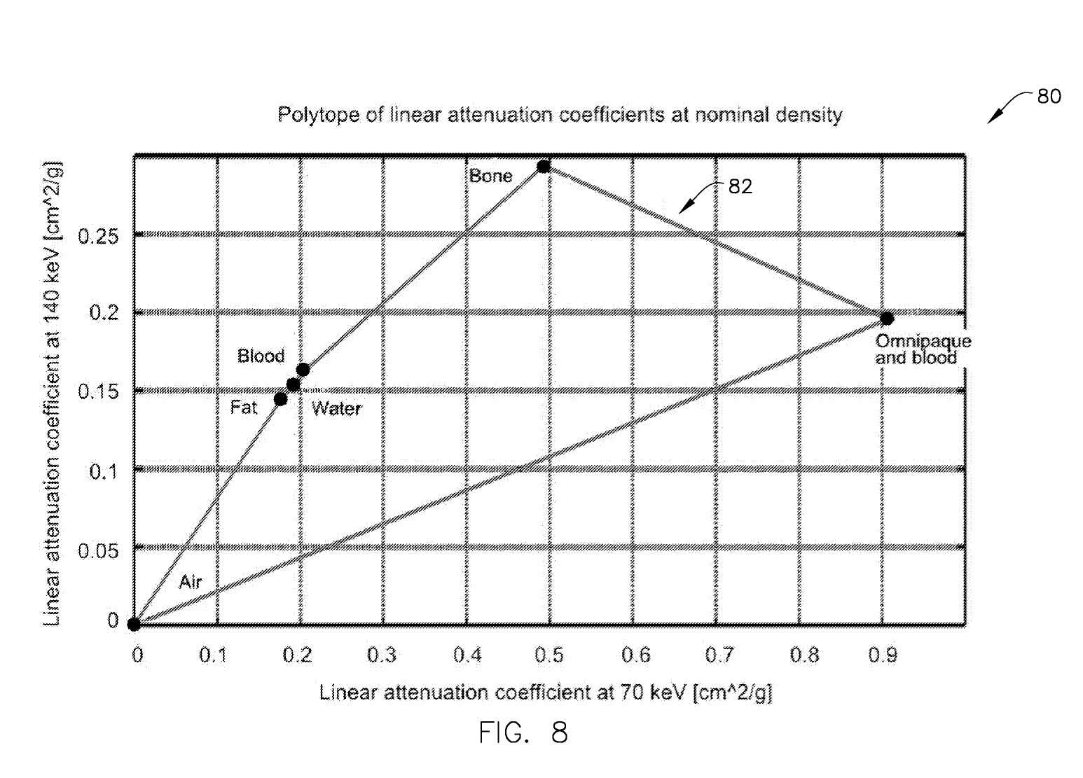

By way of explanation for step 72, because of the constraints in equations (5a) and (5b), the energy-independent constants αᵢ in Equation (1) can be viewed as weights in a combination of the linear attenuation coefficients of the respective component materials, in the imaged aggregate of component materials, at the nominal material densities. It can be appreciated by one skilled in the art that material's linear attenuation properties at two arbitrary, but fixed, energy levels E₁ and E₂ can be represented as a point in a two-dimensional space having coordinates μ_{L}=(μ_{L}(E₁),μ_{L}(E₂)) E₁. This may be exemplified by a graph 80, shown in FIG. 8. The graph 80 shows dual-energy linear attenuation coefficient values of N arbitrary materials plotted along orthogonal axes. When the material mix in the human body is modeled as an ideal solution, μ_{L} is inside the convex hull [symbol] of the set {μ_{L,i}, i=1, 2, . . . , N}. That is, the linear attenuation coefficients for a given energy pair fall within the convex hull 82 of the linear attenuation coefficients of the imaged aggregate of component materials.

However, for N>3, the condition that μ_{L}ε [symbol] serves to constrain only the range of the energy-independent coefficients αᵢ, and is not adequate to fully specify the values of the coefficients αᵢ. In this case, a unique solution can be obtained by adding the further constraint that a suitable function ƒ of the vector α=(α₁,α₂, . . . , α_{N}) is minimal, and an N-material decomposition for N>3 can be obtained by solving the optimization problem given by:

$$α *= {min}_{α} f ( α ) \qquad ( 7 )$$

and by meeting the conditions of Equations 1, 5a, and 5b, above.

In accordance with the disclosed method, multi-material (N>3) decomposition is achieved through the introduction of further constraints on the weights of the weighted sum of the linear attenuation curves. Such further constraints include, for example, data-fidelity constraints, constraints based on the spatial dependency of voxels, and constraints derived from prior knowledge of the operator.

For N>3, the disclosed process can be further expanded by introducing a regularization function to the otherwise unconstrained solution of the N-material decomposition problem. The regularization function for determining the multiple material contributions, at step 76, can be selected depending on the anatomy that is being looked at based on a priori knowledge of the common characteristics of the material make-up of the relevant anatomy. For example, if the operator is looking at the liver, the regularization function may be tailored to favor water, iohexol, and blood over bone.

In an exemplary embodiment of the disclosed method, step 74 can be carried out off-line to create a lookup table for interactive visualization of the results. Multiple look up tables may be pre-generated with decompositions across different sets of materials. The particular table to be used for a decomposition can be chosen based on the anatomy/region of interest based on the a priori knowledge of the material make-up of that region. Moreover, the lookup tables may be generated ‘on the fly’ based on user input. The operator could specify the materials of interest based on some ambiguity to be resolved, or else interact with a scatter plot feature and to define the convex hull manually.

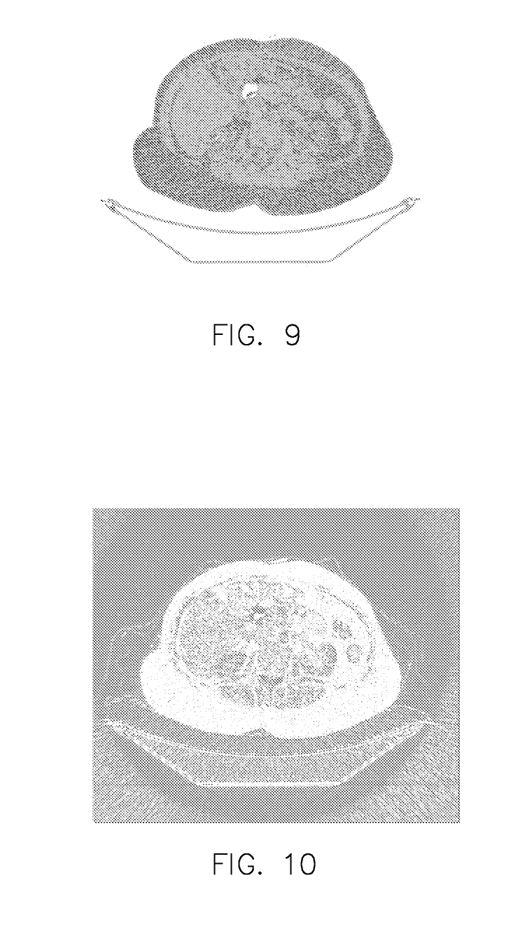

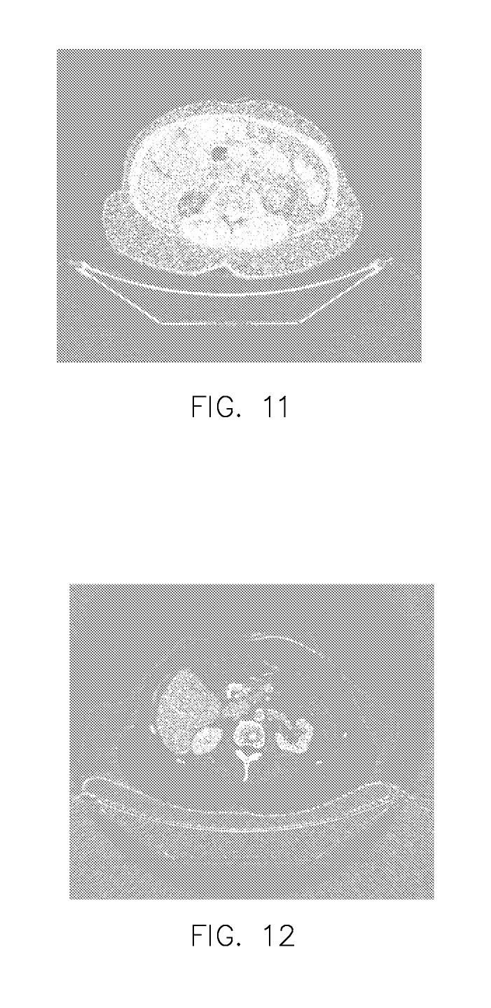

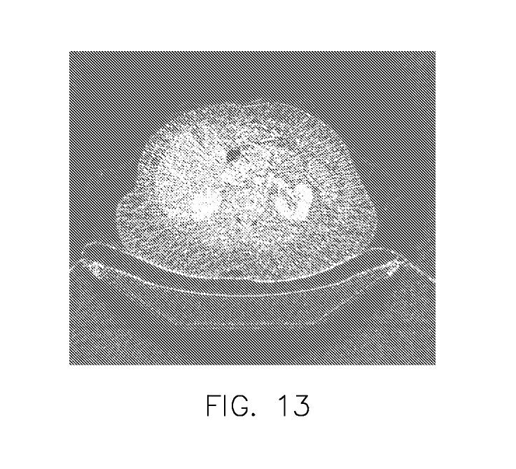

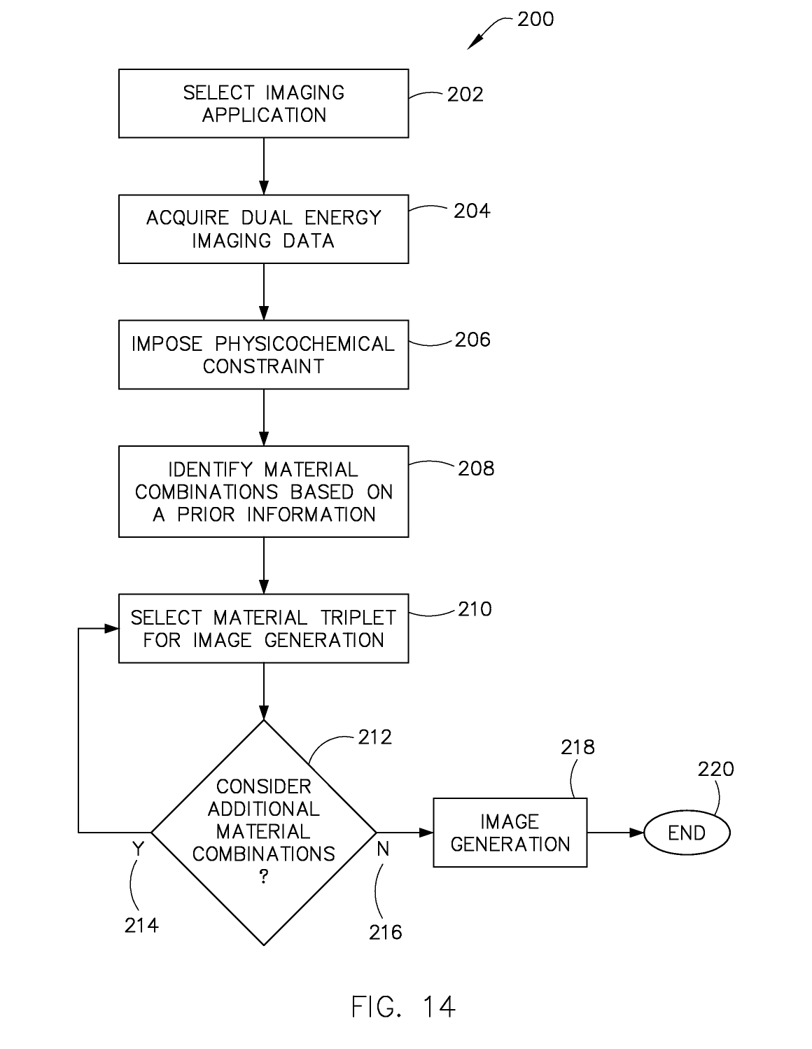

Example of the multi-material decomposition performed at step 76 of flow chart 60 are provided in the images of FIGS. 9-13. FIG. 9 is an air component image obtained with multi-material decomposition. FIG. 10 is a fat component image, FIG. 11 is a blood component image, FIG. 12 is a bone component image, and FIG. 13 is an Omnipaque-component image. The images resulting from this type of multi-decomposition have fractional voxel values that represent the contribution from a particular material. These images can be leveraged in a number of ways, including without limitation, the following examples:
A weighting function on a monochromatic image to represent the attenuation due to a particular material—this would include the multiplication of a particular monochromatic image by the volume fraction image;
AIR image can be used to identify contours of the body and interior vacuous regions (e.g., used for lung segmentation by counting the number of crossings in and out of this AIR region);
Segmentation based on threshold volume fraction (e.g., bone is the region that is >90% volume fraction on the bone image);
Providing a color overlay on top of standard images showing color intensity based on volume fraction image;
Inputting to a generalized segmentation engine—where one or more volume fraction images that result from the multi-material decomposition procedure are used in a material segmentation process;
Generating a virtual non-contrast image by replacing volume fraction associated with the Omnipaque with another component such as blood; and
Liver fat quantification, or general fat quantification, by using a fat-volume fraction image.

The plurality of detector modules 20 sense the projected x-rays that pass through the patient 22, and the data acquisition system 32 converts the data to digital signals for subsequent processing. Each detector module 20 in a conventional system produces an analog electrical signal that represents the intensity of an attenuated x-ray beam after it has passed through the patient 22. During a scan to acquire x-ray projection data, the gantry 12 rotates about a center of rotation 24 along with the x-ray source 14 and the detector assembly 15.

Thus, as described, multi-material decomposition includes an algorithm that performs material decomposition over a number of different materials which, in one embodiment, may be a material triplet. However, not all tissue can be divided clearly or cleanly into three materials, and therefore there is a need to be able to assess more than three materials. If more than three materials are selected for multi-material decomposition, then the algorithm attempts to find the best three material candidates that best describe the material.

This works in general, but can be made to work better if the three materials the algorithm must choose are defined based on the specific application at hand. Thus, a material triplet may be selected based on the anatomy that is being imaged. As stated and as an example, if an operator or imaging clinician is imaging a liver, then a material triplet may be based on water, iohexol, and blood.

For neuro applications, one set of materials may be more applicable than another set of materials for a kidney stone application, for example. Additionally, a virtual non-contrast application may include an additional set of materials. There may also be a workflow by which a set of materials may be defined for multi-material decomposition either from scratch or by starting from a reference starting point that is driven by the specific application.

Additional applications together with typical related materials of interest are listed below as examples:

1. Kidney stone characterization, and materials for different stones may include: cystine, struvite, uric acid, calcium oxalate;
2. Virtual non contrast: contrast agent, fat, water, blood, bone;
3. Soft plaque analysis and differentiation: fibrous, fatty, mixed plaque materials;
4. Body fat measurement based on water, bone;
5. Liver fat measurement based on water, iohexol, and blood;
6. Calcium-iodine separation for CT-angiography (CTA) exams based on calcium and iodine;
7. Calcium scoring for Cardiac exams (focus on calcium vs. noncalcium);
8. Qualitative perfusion measurements (looking at iodine fraction in tissue);
9. Gout (looking for uric acid deposits or crystallized uric acid).

Further, it is possible to select material options for a material triplet based on other aspects related to an imaging session and by using data that is typically available to an imaging clinician, or may be readily made available thereto. Such aspects include but are not limited to:

a.) A preconfigured database identifying a list of materials as a set of point locations in the 2D scatter plot representation along with the nominal densities of such materials.
b.) Mass attenuation curves of materials and their nominal densities.
c.) Workflow where materials are suggested to the user or automatically selected based off scanned anatomy or application protocol.
d.) Selecting a proper decomposition pair from a known volume fraction. For example, with contrast studies timing and blood flow are known, and an amount of omnipaque distributed is also known.

In some imaging applications, the presence of some materials may be known based on other aspects of the imaging application. For instance, a presence of contrast agent such as omnipaque may be known, based on knowledge that the imaging data acquired was obtained during a contrast injection. Then, for a given dataset, either a set of materials among which a decomposition is performed can be optimized, or more informed decisions about how a decomposition should be performed may be known or inferred. Thus, material selection of a material triplet may be given to a user or clinician who may then select the contrast agent as one of the materials of the material triplet, according to an embodiment of the invention.

Thus, presenting a list of three material combinations based on earlier obtained data, from the many thousands of total possible material combinations, can dramatically decrease time and effort for a user. For instance, by generating a reduced universe of possible material combinations and prompting a user or clinician to review the possible material combinations to select a combination, scanning resources can accordingly be reduced.

As such, according to an embodiment of the invention, the universe of possible material combinations may be downselected or reduced based on information that is known prior to obtaining imaging data. For instance, as stated, kidney stone characterization may be based on a content of cystine, struvite, uric acid, calcium oxalate. Thus, knowing a priori the possible materials associated with a kidney stone, the number of possible material triplet combinations may be vastly reduced, and a three-material characterization may then be performed quickly and efficiently. Further, although the downselection process may not yield specifically only three materials for the clinician (i.e., kidney stone may be associated with four materials, cystine, struvite, uric acid, calcium oxalate), or known a priori information may include less than three materials (i.e., CTA exams based on calcium and iodine), the universe of possible material triplets may nevertheless be vastly reduced by making use of what information is known a priori, thus dramatically reducing time and resources to generate images and make a diagnosis based thereon.

FIG. 14 is a flow diagram illustrating material triplet selection for a multi-material decomposition. Referring to FIG. 14, a technique 200 includes selecting an imaging application at step 202, and acquiring dual energy imaging data at step 204. At step 206 a physicochemical model or constraint is imposed to enable a three-material basis material solution. Based on information obtained a priori, possible material combinations are downselected at step 208. As stated, the a priori information used to downselect material options includes but is not limited to a selected imaging application from step 202, which may in turn be based on target image materials or surrounding tissue thereof, as examples.

At step 210, a material triplet is selected for image generation. Material triplet selection may be performed by an algorithm that is based on keywords within an imaging protocol, or based on input by a clinician or user, as examples. Conversely, material triplet selection may be determined via user selection after prompting the user with a range of possible materials or material combinations. For instance, if one material is known or expected with a high degree of probability, based on a priori knowledge, then the user may be presented with a list of materials or material options that take into account the one known material, and a truncated or reduced list may then be generated. Thus, in this example, though the list of possible material triplets is not deterministically reduced to three options, the number of possible materials and material combinations is nevertheless dramatically reduced, according to the invention. Likewise, if for instance two materials are deemed to have a high degree of probability based on a priori information, such as water and bone, then the list of possible material triplets is dramatically reduced, yet more, when compared to the example having one known material.

Once selected, the user may again be prompted whether to consider a different material combination at step 212. If the user desires to select a different material combination 214, then control is returned to step 208 and control again returns to step 214. Once no further material combinations are to be considered 216, then image generation occurs at step 218, and technique 200 ends at step 220.

The above-described methods can be embodied in the form of computer program code containing instructions embodied in one or more tangible media, such as floppy diskettes and other magnetic storage media, CD ROMs and other optical storage media, flash memory and other solid-state storage devices, hard drives, or any other computer-readable storage medium, wherein, when the computer program code is loaded into and executed by a computer, the computer becomes an apparatus for practicing the disclosed method.

According to one embodiment of the invention, an imaging system includes an x-ray source configured to emit a beam of x-rays toward an object to be imaged, a detector configured to receive x-rays that are attenuated by the object, a data acquisition system (DAS) operably coupled to the detector, and a computer operably coupled to the DAS. The computer is programmed to obtain scan data with two or more incident energy spectra, identify one or more material triplet combinations based on data obtained prior to obtaining the scan data, decompose the obtained scan data into three or more basis materials based on the identified one or more material triplet combinations, and generate an image using the decomposed scan data.

According to another embodiment of the invention, a method of multi-energy imaging includes selecting an imaging application for a multi-energy image acquisition, acquiring imaging data, based on the selected imaging application, with an x-ray source powered to a first keV and to a second keV, determining a plurality of three-material combinations based on data obtained prior to acquiring the imaging data, selecting one of the plurality of three-material combinations, decomposing the imaging data into three materials based on the selected three-material combination, and generating an image using the decomposed imaging data.

According to yet another embodiment of the invention, a computer readable storage medium having stored thereon a computer program configured to acquire energy-sensitive imaging data of an object, identify at least one possible material triplet of a multi-material combination to a user, receive a user selection of one of the plurality of possible material triplets, and reconstruct an image based on the selected possible material triplets.

While the invention is described with reference to exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An imaging system comprising:
an x-ray source configured to emit a beam of x-rays toward an object to be imaged;
a detector configured to receive x-rays that are attenuated by the object;
a data acquisition system (DAS) operably coupled to the detector; and
a computer operably coupled to the DAS and programmed to:
obtain scan data with two or more incident energy spectra;
identify one or more material triplet combinations based on data obtained prior to obtaining the scan data;
decompose the obtained scan data into three or more basis materials based on the identified one or more material triplet combinations; and
generate an image using the decomposed scan data.

2. The imaging system of claim 1 wherein the data obtained prior to obtaining scan data includes an anatomy of the object to be imaged.

3. The imaging system of claim 1 wherein the computer is programmed to identify the one or more material triplet combinations based on a priori data of characteristics of a material make-up of the object.

4. The imaging system of claim 1 wherein the computer is programmed to prompt a user to select an imaging application, and wherein the selected imaging application comprises the data obtained prior to obtaining the scan data.

5. The imaging system of claim 1 wherein the computer is programmed to:
prompt a user to select one or more possible material triplet combinations; and
identify the one or more material triplet combinations from the user-selected one or more possible material triplet combinations.

6. The imaging system of claim 1 wherein the computer is programmed to identify the one or more material triplet combinations from a group of materials comprising cystine, struvite, uric acid, calcium oxalate, fat, water, blood, bone, plaque, fibrous material, iohexol, or iodine.

7. The imaging system of claim 1 wherein the data obtained prior to obtaining the scan data comprises data corresponding to a selected imaging application.

8. The imaging system of claim 7 wherein the selected imaging application comprises one of a kidney stone characterization, a soft plaque analysis, a body fat measurement, a liver fat measurement, a CT-angiography, a calcium scoring cardiac exam, a perfusion measurement, and a gout assessment.

9. A method of multi-energy imaging, the method comprising:
selecting an imaging application for a multi-energy image acquisition;
acquiring imaging data, based on the selected imaging application, with an x-ray source powered to a first keV and to a second keV;
determining a plurality of three-material combinations based on data obtained prior to acquiring the imaging data;
selecting one of the plurality of three-material combinations;
decomposing the imaging data into three materials based on the selected three-material combination; and
generating an image using the decomposed imaging data.

10. The method of claim 9 wherein determining the plurality of three-material combinations comprises determining the possible three-material combinations based on earlier obtained data, obtained prior to the step of acquiring the imaging data, that is a priori knowledge of characteristics of a material make-up of the object.

11. The method of claim 9 comprising prompting a user to select the imaging application, and wherein the step of determining the plurality of three-material combinations comprises determining the plurality of three-material combinations based on the user-selected imaging application.

12. The method of claim 9 comprising presenting the plurality of three-material combinations to a user, and wherein the step of selecting one of the plurality of three-material combinations comprises prompting the user to select one of the determined three-material combinations.

13. The method of claim 9 wherein determining the plurality of three-material combinations comprises determining the plurality of three-material combinations based on at least one of cystine, struvite, uric acid, calcium oxalate, fat, water, blood, bone, plaque, fibrous material, iohexol, and iodine.

14. The method of claim 9 wherein the step of selecting the imaging application comprises selecting one of a kidney stone characterization, a soft plaque analysis, a body fat measurement, a liver fat measurement, a CT-angiography, a calcium scoring cardiac exam, a perfusion measurement, and a gout assessment.

15. A computer readable storage medium having stored thereon a computer program configured to:
acquire energy-sensitive imaging data of an object;
identify at least one possible material triplet of a multi-material combination to a user;
receive a user selection of one of the plurality of possible material triplets; and
reconstruct an image based on the selected possible material triplets.

16. The computer readable storage medium of claim 15 wherein each possible material triplet of the at least one possible material triplets comprises a combination of three materials selected from the group comprising cystine, struvite, uric acid, calcium oxalate, fat, water, blood, bone, plaque, fibrous material, iohexol, and iodine.

17. The computer readable storage medium of claim 15 wherein the computer program is configured to prompt the user to select an imaging application for imaging the object.

18. The computer readable storage medium of claim 17 wherein the computer program is further configured to identify the at least one possible material triplet based on the selected imaging application.

19. The computer readable storage medium of claim 17 wherein the imaging application is one of a kidney stone characterization, a soft plaque analysis, a body fat measurement, a liver fat measurement, a CT-angiography, a calcium scoring cardiac exam, a perfusion measurement, and a gout assessment.

20. The computer readable storage medium of claim 15 wherein the computer is further configured to determine the at least one possible material triplet based on earlier obtained data that is a priori knowledge of characteristics of a material make-up of the object and is acquired prior to acquiring the energy-sensitive imaging data of the object.

21. The computer readable storage medium of claim 15 wherein, in being programmed to select one of the plurality of possible material triplets, the computer is programmed to present the at least one possible material triplet to the user and prompt the user to select the one of the possible material triplet combinations.
